(19) United States
(12) Patent Application Publication
(10) Pub. No.: US 2013/0340586 A1
(43) Pub. Date: Dec. 26, 2013

(54) PUNCHING DEVICE

(71) Applicant: Chin-Wen Yen, Tainan City (TW)

(72) Inventor: Chin-Wen Yen, Tainan City (TW)

(21) Appl. No.: 13/756,216

(22) Filed: Jan. 31, 2013

(30) Foreign Application Priority Data
Jun. 22, 2012 (TW) 101122458

(51) Int. Cl. B26D 5/10

(52) U.S. Cl. CPC B26D 5/10
USPC 83/582

(57) ABSTRACT

A punching device includes: a die seat; a punch seat; an interconnecting member interconnecting a first end portion of the die seat and a first end portion of the punch seat; a punch supported movably on the punch seat; a first pivot part extending from at least one of the first end portion of the die seat and the first end portion of the punch seat; a second pivot part extending from a second end portion of one of the punch seat and the die seat; a lever mechanism including first and second levers, the first lever being pivoted to the first pivot part, the second lever being pivoted to the second pivot part for pressing one end of the first lever; and an urging member for urging the punch away from the die seat.

### CROSS-REFERENCE TO RELATED APPLICATIONS

This application claims priority of Taiwanese Application No. 101122458, filed on Jun. 22, 2012.

### BACKGROUND OF THE INVENTION

1. Field of the Invention

This invention relates to a punching device, more particular to a punching device including an interconnecting member interconnecting a die seat and a punch seat and a lever mechanism designed to reduce a torque applied to a corner between the interconnecting member and the punch seat during punching.

2. Description of the Related Art

FIG. 1 illustrates a conventional punching device 1, which is disclosed in U.S. Pat. No. RE38219, for punching or embossing a sheet material to create a desired decorative shape for a decorative project, such as scrapbooking or other crafts. The punching device 1 includes a die seat 111, a punch seat 112, an interconnecting member 113 interconnecting one end of the die seat 111 and one end of the punch seat 112, a punch 12 supported movably on the punch seat 112, a pivot part 117 extending upwardly from the other end 1121 of the punch seat 112, a lever 14 pivoted to the pivot part 117 and provided with a protrusion 143 that is in contact with a top end of the punch 12, and an urging member 13 for urging the punch 12 to move away from the die seat 111. The punch seat 112 is disposed above and cooperates with the die seat 111 to define a sheet-receiving gap 118 therebetween for receiving a paper sheet (not shown) to be punched. The die seat 111, the punch seat 112, and the interconnecting member 113 are in the form of a single piece of a rigid material, such as plastics or metal.

The Applicant found that since the walls of the single piece forming the die seat 111, the punch seat 112, and the interconnecting member 113 are relatively thin, which reduces the cost and weight of the punching device 1, the interconnecting member 113 and a corner 115 between the punch seat 112 and the interconnecting member 113 tend to deform or be damaged after a period of use. The Applicant also found that the problem is attributed to the generation of a counter force (F) that acts on the pivot part 117 and is transmitted to the other end 1121 of the punch seat 112 when the lever 14 is pressed downward. The counter force (F) creates a torque (T), which is the product of the counter force (F) and a horizontal distance between the interconnecting member 113 and the other end 1121 of the punch seat 112, applied to the interconnecting member 113 and the corner 115 during the punching operation.

### SUMMARY OF THE INVENTION

Therefore, an object of the present invention is to provide a punching device with a lever mechanism that can reduce the torque applied to the interconnecting member and the corner between the interconnecting member and the punch seat of the punching device during punching, thereby preventing deformation or damage to the interconnecting member and the corner.

According to the present invention, there is provided a punching device that comprises: a die seat having opposite first and second end portions and formed with a die hole that is disposed between the first and second end portions, the first and second end portions being opposite to each other in an insertion direction; a punch seat disposed above the die seat and having opposite first and second end portions that are respectively disposed adjacent to the first and second end portions of the die seat, the punch seat and the die seat cooperatively defining a sheet-receiving gap therebetween; an interconnecting member interconnecting the first end portion of the die seat and the first end portion of the punch seat and confining one side of the sheet-receiving gap; a punch supported movably on the punch seat so as to be movable relative to the die seat into the die hole; a first pivot part extending from at least one of the first end portion of the die seat and the first end portion of the punch seat; a second pivot part opposite to the first pivot part in the insertion direction and extending from one of the second end portion of the punch seat and the second end portion of the die seat; a lever mechanism including first and second levers, the first lever having opposite first and second end portions and a contact portion that is disposed between the first and second end portions of the first lever for pressing the punch, the first end portion of the first lever being pivoted to the first pivot part, the second lever having opposite first and second end portions and a contact portion that is disposed between the first and second end portions of the second lever for pressing the second end portion of the first lever, the second end portion of the second lever being pivoted to the second pivot part; and an urging member for urging the punch to move in a direction away from the die hole.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional punching device;

FIG. 2 is a perspective view of the first preferred embodiment of a punching device according to the present invention;

FIG. 3 is an exploded perspective top view of the first preferred embodiment;

FIG. 4 is an exploded perspective bottom view of the first preferred embodiment;

FIG. 5 is a sectional view taken along lines V-V of FIG. 2;

FIG. 6 is a side view of the first preferred embodiment (a second lever is not shown for showing an inside of the punching device);

FIG. 7 is another side view of the first preferred embodiment;

FIG. 8 is a sectional view illustrating a punching state of the first preferred embodiment;

FIG. 9 is a sectional view of the second preferred embodiment of the punching device according to the present invention;

FIG. 10 is an exploded perspective view of the third preferred embodiment of the punching device according to the present invention;

FIG. 11 is a sectional view of the third preferred embodiment; and

FIG. 12 is a sectional view of the fourth preferred embodiment of the punching device according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

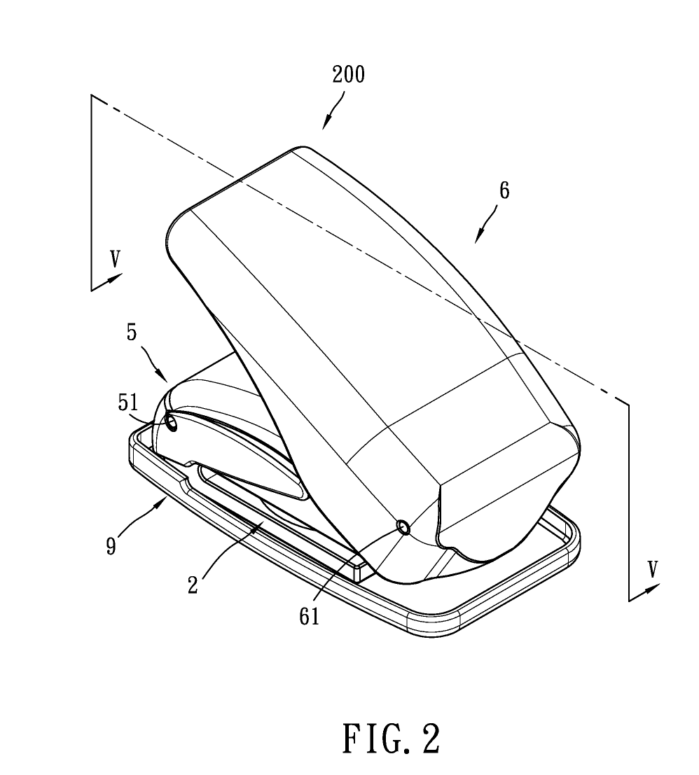

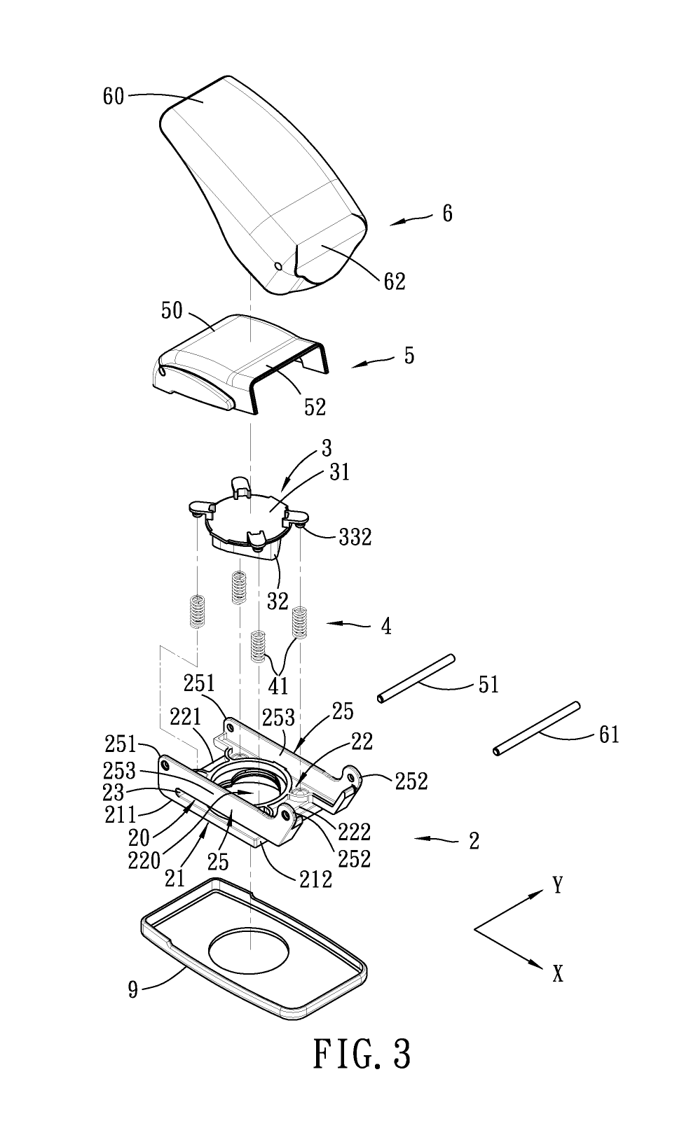

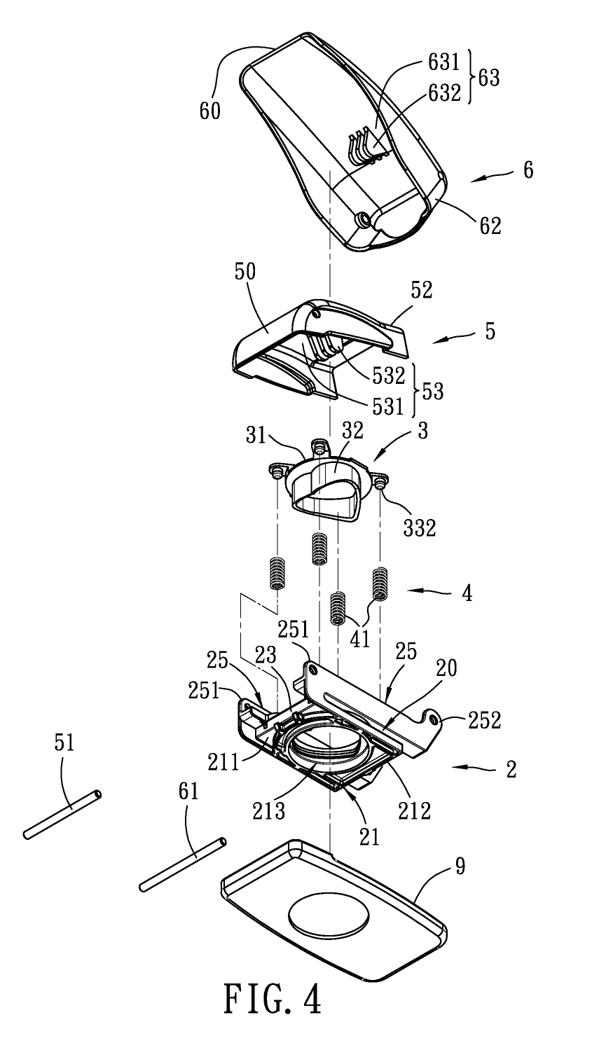

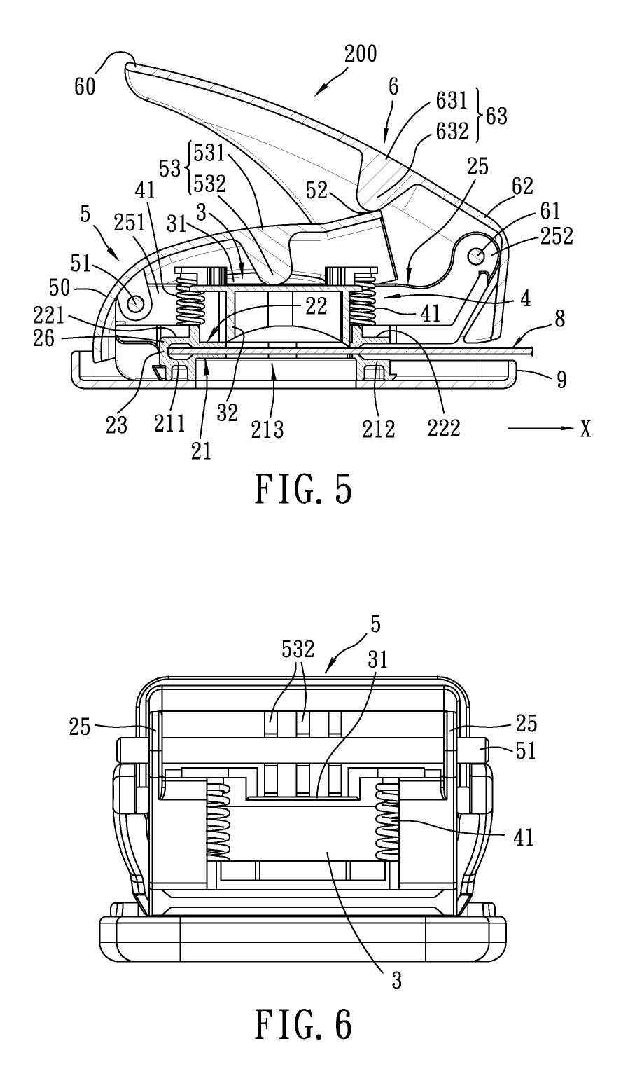

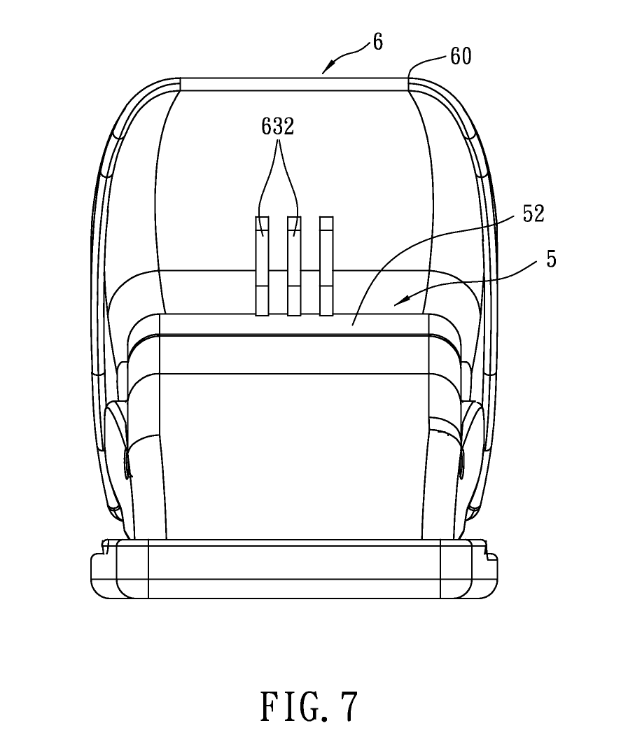

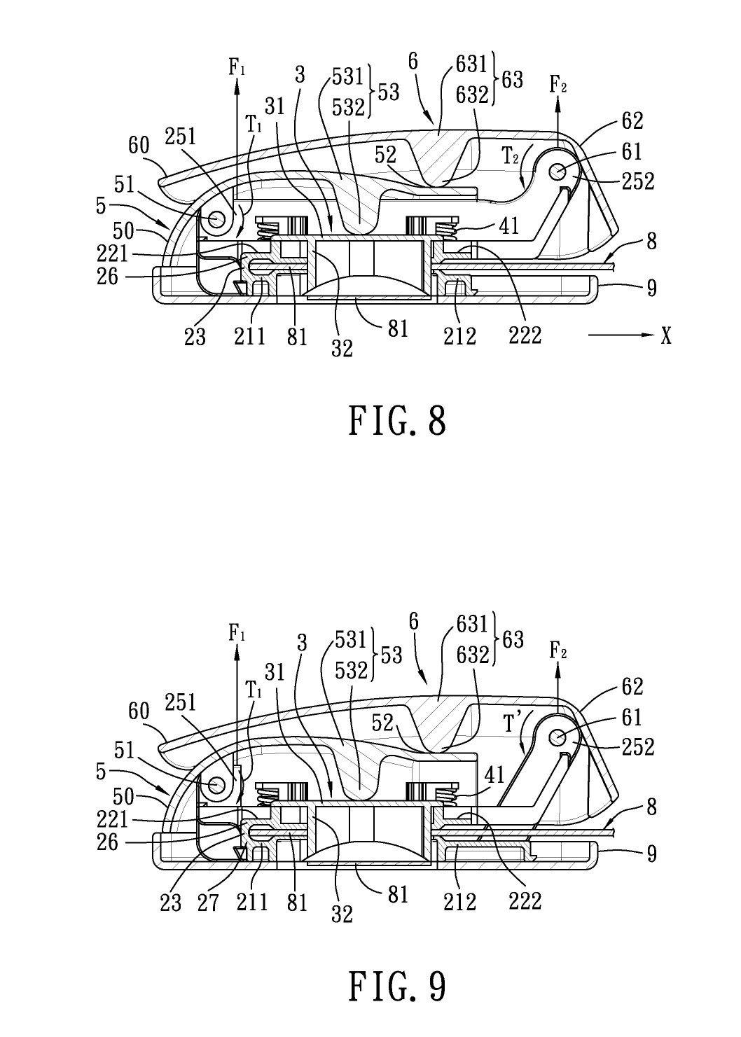

FIGS. 2 to 7 illustrate the first preferred embodiment of a punching device 200 according to the present invention. The punching device 200 may be used to cut or emboss a sheet 8 (see FIGS. 5 and 8) of a material, such as paper or plastics, so as to form a desired pattern for the material.

The punching device 200 includes a bottom cover 9, a main support 2, a punch 3, an urging member 4, and a lever mechanism.

The main support 2 includes a die seat 21, a punch seat 22, an interconnecting member 23, and a pair of pivot-linking plates 25. The die seat 21 extends into and releasably engages the bottom cover 9, has opposite first and second end portions 211, 212, and is formed with a die hole 213 disposed between the first and second end portions 211, 212. The first and second end portions 211, 212 are opposite to each other in an insertion direction (X).

The punch seat 22 is disposed above the die seat 21 and has opposite first and second end portions 221, 222 that are respectively disposed adjacent to the first and second end portions 211, 212 of the die seat 21. The punch seat 22 and the die seat 21 cooperatively define a sheet-receiving gap 20 therebetween for receiving the sheet 8. The interconnecting member 23 is disposed between and interconnects the first end portion 211 of the die seat 21 and the first end portion 221 of the punch seat 22 and confines one side of the sheet-receiving gap 20 to stop further advancement of the sheet 8 in the insertion direction (X). The interconnecting member 23 and the first end portion 221 of the punch seat 22 cooperatively define a first corner 26 therebetween. The pivot-linking plates 25 are transverse to the punch seat 22 and are connected to two opposite sides of the punch seat 22, respectively. Each of the pivot-linking plates 25 has a first pivot part 251, a second pivot part 252 opposite to the first pivot part 251 in the insertion direction (X), and a middle part 253 interconnecting the first and second pivot parts 251, 252. The first pivot parts 251 of the pivot-linking plates 25 extend from the first end portion 211 of the die seat 21 and the first end portion 221 of the punch seat 22. Alternatively, the first pivot parts 251 of the pivot-linking plates 25 can extend from one of the first end portion 211 of the die seat 21 and the first end portion 221 of the punch seat 22. The second pivot parts 252 of the pivot-linking plates 25 extend upwardly from the second end portion 222 of the punch seat 22.

In this embodiment, the main support 2 is in the form of a single piece of a rigid material, such as plastics or metal, and the interconnecting member 23 has a vertically extending plate. Alternatively, the interconnecting member 23 can be in the form of a set of magnets (not shown) secured to the die seat 21 and the punch seat 22, respectively.

The punch 3 is supported movably on the punch seat 22 so as to be movable relative to the die seat 21 into the die hole 213 in a vertical direction, and has a top wall 31 that is provided with a plurality of studs 332, and a blade 32 extending downwardly from the top wall 31.

The urging member 4 includes a plurality of coil springs 41 mounted to and abutting against the studs 332 and the punch seat 22 for urging the punch 3 to move in a direction away from the die hole 213. Alternatively, the urging member 4 can be in the form of a single coil spring (not shown) surrounding the punch 3.

The lever mechanism includes first and second levers 5, 6 that are stacked one above the other. The first lever 5 has opposite first and second end portions 50, 52, and a contact portion 53 that is disposed between the first and second end portions 50, 52 of the first lever 5 and that contacts the punch 3 for pressing the punch 3. The first end portion 50 of the first lever 5 is pivoted to the first pivot parts 251 about a first pivot shaft 51 that extends in a transverse direction (Y) perpendicular to the insertion direction (X). In this embodiment, the first pivot shaft 51 is disposed above and adjacent to the interconnecting member 23. The contact portion 53 of the first lever 5 has a middle part 531 interconnecting the first and second end portions 50, 52 of the first lever 5 and a protrusion 532 protruding from the middle part 531 toward and in contact with the punch 3.

The second lever 6 has opposite first and second end portions 60, 62, and a contact portion 63 that is disposed between the first and second end portions 60, 62 of the second lever 6 and that contacts the second end portion 52 of the first lever 5 for pressing the second end portion 52 of the first lever 5. The second end portion 62 of the second lever 6 is pivoted to the second pivot parts 252 about a second pivot shaft 61 that extends in the transverse direction. The interconnecting member 23 is disposed between the first and second pivot shafts 51, 61 when viewed in a direction perpendicular to the insertion direction (X) and the transverse direction (Y). The contact portion 63 of the second lever 6 has a middle part 631 interconnecting the first and second end portions 60, 62 of the second lever 6 and a protrusion 632 protruding from the middle part 631 of the contact portion 63 of the second lever 6 toward and in contact with the second end portion 62 of the first lever 6.

The punch seat 22 is formed with a central hole 220 for extension of the punch 3 therethrough. The central hole 220 is disposed between the first and second end portions 221, 222 of the punch seat 22.

The first lever 5 is rotatable relative to the punch seat 22 about a first axis of the first pivot shaft 51. The second lever 6 is rotatable relative to the punch seat 22 about a second axis of the second pivot shaft 61. The second axis is parallel to the first axis, and is disposed at a level above the first axis.

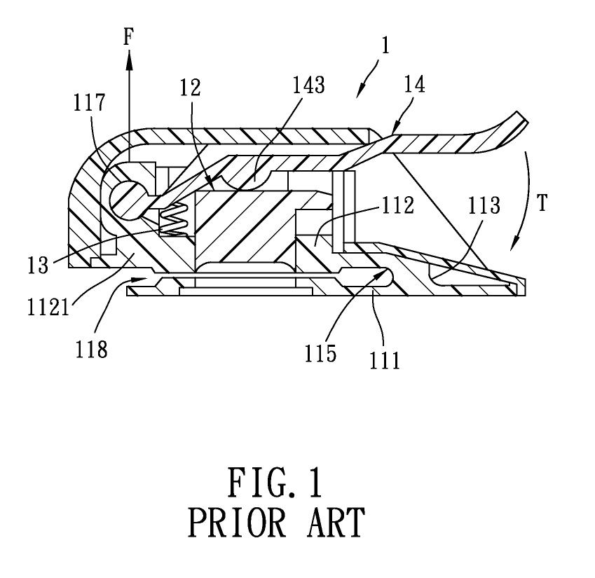

Referring to FIG. 8, in operation, the first end portion 60 of the second lever 6 is pressed downward to press the second end portion 52 of the first lever 5, which drives the punch 3 to move downward into the die hole 213 and to cut the sheet 8 into different pieces 81. During the punching operation, a first counter force (F₁), which acts on the first pivot parts 251 and is transmitted to the first end portion 221 of the punch seat 22, and a second counter force (F₂), which acts on the second pivot parts 252 and is transmitted to the second end portion 222 of the punch seat 22, are generated (see FIG. 8). The first counter force (F₁) creates a first torque (T₁), which is the product of the first counter force (F₁) and a horizontal distance in the insertion direction (X) between the first axis and the interconnecting member 23, applied to the interconnecting member 23 and the first corner 26. Since the first pivot shaft 51 is disposed adjacent to the interconnecting member 23, the horizontal distance between the first axis and the interconnecting member 23 is small, i.e., the first torque (T₁) is small too. Hence, the first torque (T₁) will not cause deformation or damage to the interconnecting member 23 and the first corner 26. The second counter force (F₂) creates a second torque (T₂), which is the product of the second counter force (F₂) and the horizontal distance between the second axis and the interconnecting member 23, applied to the interconnecting member 23 and the first corner 26. According to the lever principle, the force output from the protrusion 632 is much less than that from the protrusion 532, i.e., the second counter force (F₂) is considerably reduced as compared to the counter force (F) of the prior art shown in FIG. 1. As such, the second toque (T₂) is much less than the torque (T) of the prior art, thereby preventing deformation or damage to the interconnecting member 23 and the first corner 26 when the interconnecting member 23 is in the form of a vertical plate and also preventing undesired disconnection between the punch seat 22 and the die seat 21 when the interconnecting member 23 is in the form of a set of magnets connected to the punch seat 22 and the die seat 21.

FIG. 9 illustrates the second preferred embodiment of the punching device 200 according to the present invention. The second preferred embodiment differs from the previous embodiment in that the second pivot parts 252 extend upwardly from the second end portion 212 of the die seat 21. As such, the second counter force (F₂) acts on the second pivot parts 252 and is transmitted to the second end portion 212 of the die seat 21, and the resulting second torque (T′) is applied to the interconnecting member 23 and a second corner 27 between the interconnecting member 23 and the first end portion 211 of the die seat 21. Similar to the previous embodiment, the second torque (T′) is considerably reduced as compared to the torque (T) of the prior art.

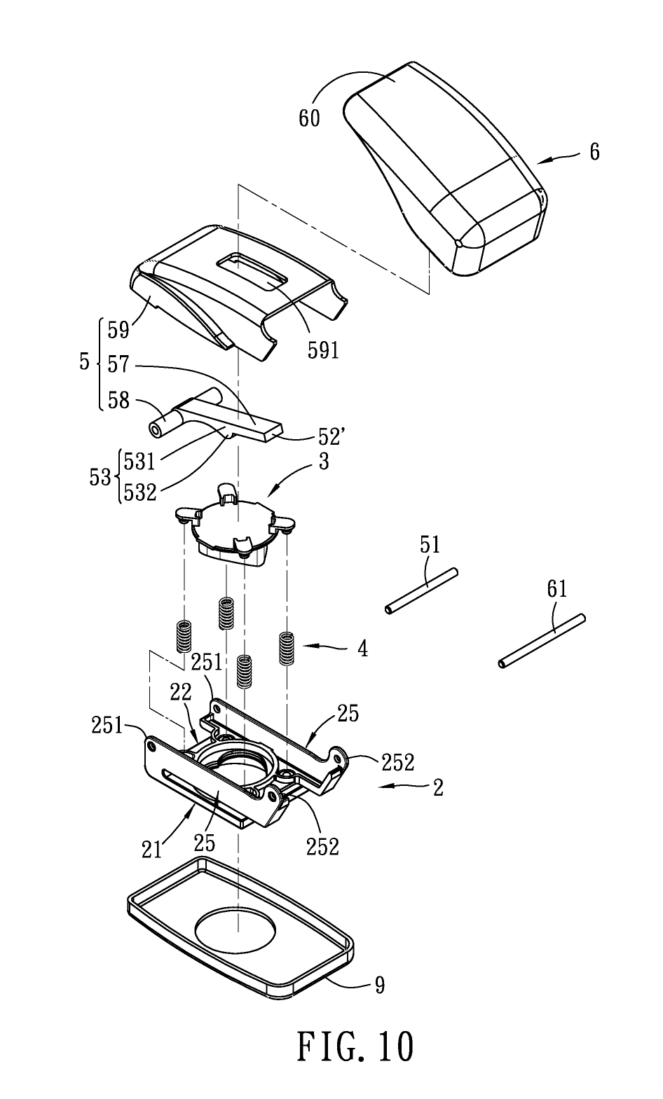

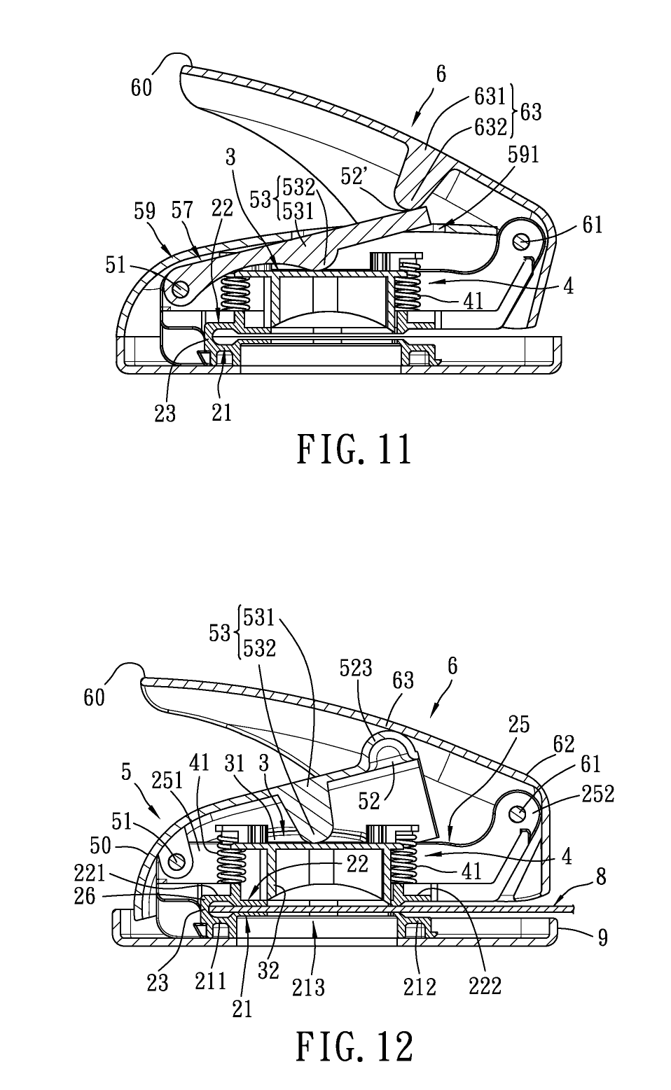

FIGS. 10 and 11 illustrate the third preferred embodiment of the punching device according to the present invention. The third preferred embodiment differs from the first embodiment in the structure of the first lever 5. In this embodiment, the first lever 5 includes a shaft sleeve 58 for extension of the first pivot shaft 51 therethrough, a lever arm portion 57 and an inner cover portion 59. The lever arm portion 57 is integrally formed with the shaft sleeve 58 so as to be pivoted to the first end portion 221 of the punch seat 22 about the first pivot shaft 51, and has a free end 52′. The inner cover portion 59 is mounted to the die seat 21, covers the punch 3 and a segment of the lever arm portion 57, and is formed with a top window 591. The free end 52′ of the lever arm portion 57 extends through the top window 591 and defines the second end portion 52 of the first lever 5.

FIG. 12 illustrates the fourth preferred embodiment of the punching device according to the present invention. The fourth preferred embodiment differs from the first preferred embodiment in that the second lever 6 has no protrusion formed on the contact portion 63 of the second lever 6, that the contact portion 53 of the first lever 5 has a first protrusion 532 protruding from the middle part 531 toward and in contact with the punch 3, and that the second end portion 52 of the first lever 5 is formed with a second protrusion 523 protruding therefrom toward and in contact with the contact portion 63 of the second lever 6.

While the present invention has been described in connection with that are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A punching device comprising:
a die seat having opposite first and second end portions and formed with a die hole that is disposed between said first and second end portions, said first and second end portions being opposite to each other in an insertion direction;
a punch seat disposed above said die seat and having opposite first and second end portions that are respectively disposed adjacent to said first and second end portions of said die seat, said punch seat and said die seat cooperatively defining a sheet-receiving gap therebetween;
an interconnecting member interconnecting said first end portion of said die seat and said first end portion of said punch seat and confining one side of said sheet-receiving gap;
a punch supported movably on said punch seat so as to be movable relative to said die seat into said die hole;
a first pivot part extending from at least one of said first end portion of said die seat and said first end portion of said punch seat;
a second pivot part opposite to said first pivot part in the insertion direction and extending from one of said second end portion of said punch seat and said second end portion of said die seat;
a lever mechanism including first and second levers, said first lever having opposite first and second end portions and a contact portion that is disposed between said first and second end portions of said first lever for pressing said punch, said first end portion of said first lever being pivoted to said first pivot part, said second lever having opposite first and second end portions and a contact portion that is disposed between said first and second end portions of said second lever for pressing said second end portion of said first lever, said second end portion of said second lever being pivoted to said second pivot part; and
an urging member for urging said punch to move in a direction away from said die hole.

2. The punching device of claim 1, wherein said contact portion of said first lever has a middle part interconnecting said first and second end portions of said first lever, and a protrusion protruding from said middle part toward said punch.

3. The punching device of claim 2, wherein said contact portion of said second lever has a middle part interconnecting said first and second end portions of said second lever, and a protrusion protruding from said middle part of said contact portion of said second lever toward said second end portion of said first lever.

4. The punching device of claim 1, wherein said contact portion of said first lever has a middle part interconnecting said first and second end portions of said first lever and a first protrusion protruding from said middle part toward said punch, said second end portion of said first lever being formed with a second protrusion protruding therefrom toward said contact portion of said second lever.

5. The punching device of claim 1, wherein said first pivot part extends from said first end portion of said die seat and said first end portion of said punch seat, and said second pivot part extends upwardly from said second end portion of said punch seat.

6. The punching device of claim 1, wherein said first pivot part extends from said first end portion of said die seat and said first end portion of said punch seat, and said second pivot part extends upwardly from said second end portion of said die seat.

7. The punching device of claim 1, further comprising first and second pivot shafts extending in a transverse direction perpendicular to the insertion direction, said punch seat being formed with a central hole for extension of said punch therethrough, said central hole being disposed between said first and second end portions of said punch seat, said first and second levers being pivoted to said first and second pivot parts about said first and second pivot shafts, respectively, said interconnecting member being disposed between said first and second pivot shafts when viewed in a direction perpendicular to the insertion direction and the transverse direction.

8. The punching device of claim 1, wherein said first lever includes a lever arm portion and an inner cover portion, said lever arm portion being pivoted to said first pivot part and having a free end, said inner cover portion being mounted to said die seat, covering said punch and a segment of said first lever arm portion, and being formed with a top window, said free end of said lever arm portion extending through said top window and defining said second end portion of said first lever.

9. The punching device of claim 1, wherein said die seat, said punch seat and said interconnecting member are in the form of a single piece.

10. The punching device of claim 1, wherein said first lever is rotatable relative to said punch seat about a first axis, said second lever being rotatable relative to said punch seat about a second axis that is parallel to said first axis and that is disposed at a level above said first axis.
